(19) United States
(12) Patent Application Publication
(10) Pub. No.: US 2009/0218280 A1
(43) Pub. Date: Sep. 3, 2009

(54) Wastewater Treatment Method and System

(76) Inventor: Juan Josse, MissionViejo, CA (US)

Correspondence Address: HARNESS, DICKEY & PIERCE, P.L.C., P.O. BOX 828, BLOOMFIELD HILLS, MI, 48303, US

(21) Appl. No.: 12/083,400

(22) PCT Filed: Oct. 9, 2006
(86) PCT No.: PCT/GB2006/003755

§ 371 Date: Apr. 4, 2009

(30) Foreign Application Priority Data
Oct. 10, 2005 (GB) 0520586.9

(51) Int. Cl. C02F 3/30

(52) U.S. Cl. 210/605; 210/626; 210/142

(57) ABSTRACT

A method for treating wastewater is disclosed. In step a), a predetermined volume of the wastewater is mixed in a first receptacle with a predetermined volume of sludge-containing returned denitrified mixed liquor under anaerobic conditions for a predetermined time period to produce an anaerobically mix rich in released phosphates. In step b), at least a portion of the anaerobically treated mix is then treated in a second receptacle under aerobic and anoxic conditions to produce a part-treated mix. In step c) at least a portion of solids from the part-treated mix to produce a low reduced-solids effluent. Steps b) and c) are sequential and cyclical and the treatment in step a) occurs during one or both of steps b) and c). In an alternative method, a predetermined volume of wastewater is treated under aerobic and anoxic conditions to produce a part-treated mix. The predetermined volume of wastewater is treated in two or more distinct portions, and a predetermined time period elapses between the introduction of each of the portions. In this method, carbon present in one or more of a second or subsequent said distinct portion(s) is available for use in treatment under said anoxic conditions during step a).

### TECHNICAL FIELD

The present invention relates to wastewater treatment systems and methods, and in particular to bioreactors for the removal of organic contaminants, nutrients and suspended solids from wastewater.

### BACKGROUND ART

Bioreactors for the treatment of wastewater, such as municipal sewage, livestock wastewater and industrial wastewater, are well known. Bioreactors use several stages of treatment of the wastewater to remove or reduce nutrients such as phosphorus (poly-phosphates), nitrogen (eg. ammonia, nitrites, nitrates and total inorganic nitrogen (TIN)), biochemical oxygen demand (BOD), chemical oxygen demand (COD) and total suspended solids (TSS).

A conventional activated sludge bioreactor process for nutrient removal is preceded by coarse screening followed by primary sedimentation or fine screening using a 2 mm screen. Effluent from the primary clarifier or the fine screen is then mixed with a mixed-liquor sludge and the resultant mix is treated anaerobically, aerobically and anoxically, prior to settling/clarification and decanting of the upper, reduced solids portion of the mixture as effluent for further treatment or disposal. Anaerobic treatment allows poly-phosphate bacteria to consume volatile fatty acids present in the mix (from the wastewater) and to release phosphates to increase future phosphate uptake potential for absorbing phosphates from the wastewater. Aeration of the mixture permits nitrification by autotrophic organisms of ammonia (NH₄⁺) to nitrites (NO₂⁻) and of nitrites to nitrates (NO₃⁻). Aeration also promotes BOD consumption by heterotrophic organisms, and allows the poly-phosphate absorbing bacteria to metabolise the volatile fatty acids they had previously entrapped, and then to entrap phosphates. The poly-phosphate absorbing bacteria entrap more phosphates than they initially released, in a process known as “luxury uptake” of phosphates. Anoxic treatment promotes denitrification of the nitrates to nitrogen gas (N_{2(g)}) which is released to the atmosphere. After performing anaerobic, aerobic and anoxic treatment, the mix is allowed to settle, or clarify, for a predetermined time period after which effluent is drawn from the upper portion of the mix and disposed. The effluent may be further disinfected for use as “grey water” for irrigation, for example. Typically, a portion of the sludge is removed for dewatering and disposal, while the remaining sludge is retained in the bioreactor for treatment of further wastewater.

Bioreactors typically fall within one of two categories: continuous feed and sequential batch feed reactors (SBRs). In continuous feed bioreactors, the above described anaerobic, aerobic, anoxic and settling stages are performed in separate tanks, which are joined in series in fluid communication, the wastewater being fed continuously through the bioreactor system, as the name implies. In SBRs, a predetermined amount, or “batch”, of screened wastewater is fed from a holding tank to a single bioreactor tank where the aerobic, aerobic, anoxic and settling stages are performed in sequence, prior to adding another batch of screened wastewater to the SBR. SBRs are advantageous over continuous feed bioreactors, since fewer process tanks and therefore a relatively smaller footprint are required. However, SBRs have the disadvantage that it is not possible to provide a truly anaerobic environment, and therefore phosphate removal from the wastewater is not as effective. Also, a carbon source, such as methanol or acetic acid, must be added during the anoxic treatment stage to feed the heterotrophic organisms for denitrification.

Disadvantages common to both systems include the time required for settling and the need for disinfection of the effluent where the effluent is put to use, for example in irrigation, rather than mere disposal. In U.S. Pat. No. 6,613,222 and U.S. Pat. No. 6,875,357, hollow fibre membrane ultrafilters or microfilters have been suggested as an alternative to the settling stage in SBRs. However, the use of membrane filters as described in these patents can be problematic. The filters described force effluent through the filters at relatively high pressure (60 psi) which fouls the membranes in a manner making them difficult to clean, due to physical properties of biosolids residue.

It is an object of at least one of the preferred embodiments of the present invention to overcome or ameliorate at least one of the deficiencies of the prior art, or at least to provide a suitable alternative thereto.

### SUMMARY OF THE INVENTION

According to a first aspect of the invention there is provided a method for treating wastewater, the method comprising the steps of:

a) in a first receptacle, mixing a predetermined volume of the wastewater with a predetermined volume of sludge (as herein defined) under anaerobic conditions for a predetermined time period to produce an anaerobically treated mix;

b) in a second receptacle, treating at least a portion of the anaerobically treated mix, under aerobic and anoxic conditions to produce a part-treated mix; and

c) removing at least a portion of solids from the part-treated mix to produce a reduced-solids effluent,

wherein steps b) and c) are sequential and cyclical and the treatment in step a) occurs during one or both of steps b) and c).

By “sludge” we mean solid material from previously-treated wastewater. It preferably is delivered to the first receptacle in liquid suspension, for example as a mixed liquor.

The sludge may be provided to the first receptacle in step (a) in liquid suspension as a mixed liquor after a denitrification treatment.

The anaerobically treated mix produced in step (a) may be rich in released phosphorus.

In step (b) the anaerobically treated mixing may be further treated to reduce dissolved BOD, nitrogen and phosphorus.

Advantageously, the anaerobic step may be performed more efficiently, due to being performed in a dedicated receptacle. Also, in being performed at the same time as one or both of steps b) and c), the method can make a more efficient use of time by performing two steps at the same time.

Preferably, the treatment in step a) for one cycle occurs during one or both of steps b) and c) of a cycle preceding said one cycle.

Preferably, substantially all the anaerobically treated mix produced in step a) is used in step b).

Preferably, the at least a portion of solids removed in step c) are introduced into the first receptacle to form at least a part of the predetermined volume of denitrified liquor waste sludge in step a).

Preferably, the at least a portion of solids removed in step c) of one cycle are introduced into the first receptacle during step b) of a subsequent cycle to form at least a portion of the predetermined volume of denitrified liquor waste sludge of step a).

Preferably, in step a), the predetermined volume of the wastewater for subsequent treatment in step b) of one cycle is introduced into the first receptacle during step b) of a cycle preceding said one cycle. Also preferably, in step a), the predetermined volume of the wastewater is mixed with the predetermined volume of denitrified liquor waste sludge under anaerobic conditions to produce the anaerobically treated mix for one cycle during the step c) of a cycle preceding said one cycle.

According to another aspect of the present invention there is provided a method for treating wastewater comprising the steps of:

a) treating a predetermined volume of wastewater under aerobic and anoxic conditions to produce a part-treated mix, wherein the predetermined volume of wastewater is treated in two or more distinct portions, and a predetermined time period elapses between the introduction of each of the portions; and

b) removing at least a portion of solids from the part-treated mix to produce a reduced-solids effluent,

wherein carbon present in one or more of a second or subsequent said distinct portion(s) is available for use in treatment under said anoxic conditions during step a).

The part-treated mix produced in step (a) may have reduced dissolved BOD, nitrogen and phosphorus.

Additional carbon, typically in the form of methanol or acetic acid, is required to be introduced in prior art bioreactor systems to allow the heterotrophic organisms to convert nitrates to nitrogen gas, or to denitrify wastewater. Since carbon present in one or more of a second or subsequent said distinct portion(s) is available for use in treatment under said anoxic conditions, less additional carbon is required to be introduced in comparison with prior art systems.

Preferably, step a) comprises the steps of:

a1) aerobically treating a first portion of the predetermined volume of wastewater;

a2) introducing a second portion of the predetermined volume of wastewater to the first portion and anoxically treating the first and second portions; and

a3) aerobically treating the first and second portions.

Preferably, step a) further comprises the steps of:

a4) introducing a third portion of the predetermined volume of wastewater to the first and second portions and anoxically treating the first, second and third portions;

a5) aerobically treating the first, second and third portions; and

a6) anoxically treating the first, second and third portions.

Preferably, steps a) and b) are sequential and cyclical.

Preferably, in step a), the portions of wastewater are introduced to a predetermined volume of mixed liquor for the treatment.

Preferably, the predetermined volume of wastewater is pretreated under anaerobic conditions prior to step a). Further preferably, the anaerobic pretreatment occurs during one or both of steps a) and b), and preferably in a separate receptacle.

Preferably, the volume of effluent produced in step b) is approximately equal to the predetermined volume of wastewater treated in step a).

Alternatively, step a) may include treatment under anaerobic conditions.

Preferably, the step of removing the at least a portion of solids is performed by filtration, which may be membrane ultrafiltration or microfiltration. Preferably, the filtration is performed in a filtration receptacle and involves a cross-flow low pressure submerged membrane filtration process. As would be understood by the skilled addressee, low pressure filtration in this context is at or below atmospheric pressure. Alternatively, the step of removing the at least a portion of solids is performed by settling and clarification.

Preferably, the wastewater to be treated is pre-screened, which preferably removes solids approximately greater than 2 mm in at least one dimension.

According to an alternative embodiment of the present invention there is provided a method for treating wastewater, the method comprising the steps of:

a) in a first receptacle, mixing a predetermined volume of the wastewater with a predetermined volume of sludge (preferably as returned denitrified liquor) under anaerobic conditions for a predetermined time period to produce an anaerobically treated mix, preferably rich in released phosphate;

b) in a second receptacle, treating at least a portion of the anaerobically treated mix, under aerobic and anoxic conditions to produce a part-treated mix; and

c) removing at least a portion of solids from the part-treated mix to produce a reduced-solids effluent,

wherein the anaerobically treated mix is introduced into the second receptacle in step b) in two or more distinct portions, and a predetermined time period elapses between the introduction of each of the portions, such that carbon present in one or more of a second or subsequent said distinct portion(s) is available for use in treatment under said anoxic conditions.

Preferably, step b) of this method also comprises the steps of:

b1) introducing a first portion of the anaerobically treated mix into the second receptacle and aerobically treating the first portion;

b2) introducing a second portion of the anaerobically treated mix into the second receptacle and anoxically treating the first and second portions; and

b3) aerobically treating the first and second portions.

Preferably, step b) of this method further comprises the steps of:

b4) introducing a third portion of the anaerobically treated mix into the second receptacle and anoxically treating the first, second and third portions;

b5) aerobically treating the first, second and third portions; and

b6) anoxically treating the first, second and third portions.

Preferably, steps b) and c) are sequential and cyclical.

Preferably, the treatment in step a) occurs during one or both of steps b) and c).

Preferably, the second receptacle contains a predetermined volume of mixed liquor prior to the start of step b).

Preferably, the volume of effluent produced in step c) is approximately equal to the volume of wastewater introduced into the first receptacle in step a).

According to another aspect of the present invention there is provided a system for treating wastewater, the system comprising:

a first receptacle for anaerobic treatment of wastewater;

a second receptacle the first receptacle for distinct aerobic and anoxic treatment of anaerobic treated wastewater received from the first receptacle preferably by pumping;

means for removal of solids from a portion of the aerobically and anoxically treated wastewater; and

a controller for controlling the system to perform any one of the above described method aspects of the present invention.

There may be means for charging the first receptacle with influent wastewater (which may contain ammonia) and sludge-bearing denitrified mixed liquor from an earlier treatment.

Preferably, the ratio of the predetermined volume of the wastewater and the predetermined volume of sludge is treated in the first receptacle in step a) is about 1:1. Alternatively, the ratio may be from 1:5 to 5:1.

Preferably, the ratio of the predetermined volume of mixed liquor to the volume of the anaerobically treated wastewater is about 12:1. Alternatively, the ratio may be from 50:1 to 1:1. The SBR volume will typically depend on nutrient concentration in the wastewater.

### BRIEF DESCRIPTION OF THE DRAWINGS

Preferred embodiments of the invention will now be described, by way of example only, with reference to the accompanying drawings in which:

FIG. 1 is a schematic view of an embodiment of a bioreactor system according to the present invention; and

FIG. 2 is a schematic view of another embodiment of a bioreactor system according to the present invention.

### DETAILED DESCRIPTION. OF THE PREFERRED EMBODIMENTS OF THE INVENTION

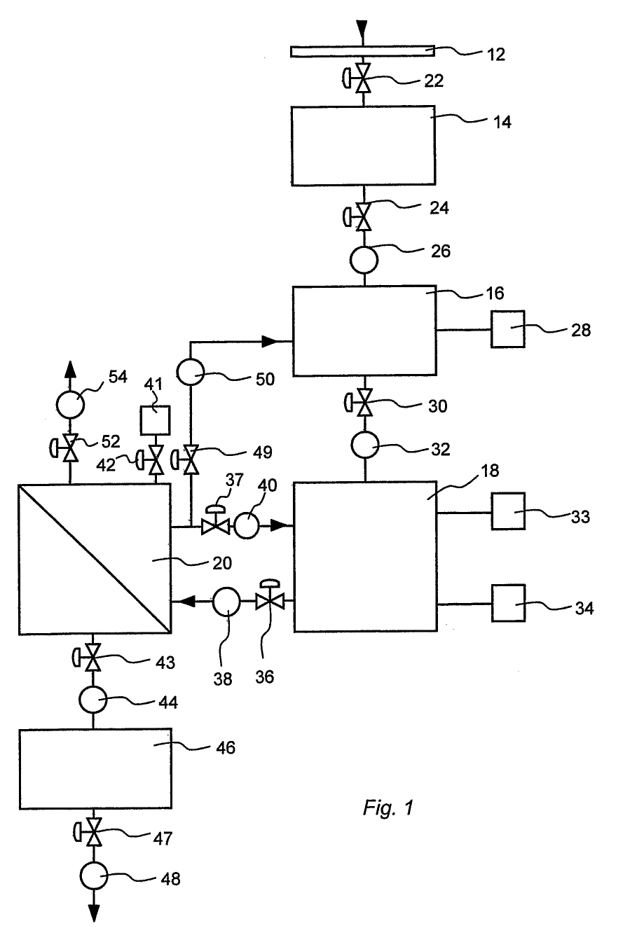

A preferred embodiment of the present invention is a method for wastewater treatment using a bioreactor system as illustrated in FIG. 1. The method is particularly useful for treating the liquid fraction of high-strength digested or undigested organic slurries and other liquid waste from food processing plants and farming operations, such as waste produced by intensive meat farming, dairy farming, anaerobic digestate from biogas production, etc.

A general description of the components of a preferred system embodiment of the present invention will now be described, prior to providing a more detailed description of the preferred method embodiment.

The system comprises a 2 mm screen 12 for screening wastewater to be treated and a feed tank 14 for storing the screened wastewater. A first receptacle in the form of a mixed anaerobic tank 16 is provided for anaerobic solids contact of the screened wastewater, and a second receptacle in the form of a sequential batch reactor (SBR) tank 18 for aerobic and anoxic treatment of the wastewater fed from the anaerobic tank 16. Means for removing at least a portion of solids from the bioreactor treated wastewater, in the form of a filtration unit 20, is provided for filtering solids from the treated wastewater from the SBR tank 18.

The feed tank 14 has level sensors to ensure the wastewater level in the tank 14 is kept within a minimum and a maximum level. When the feed tank level falls below the minimum, a first valve 22 is opened to allow preferably gravity fed screened wastewater to enter the feed tank 14. Alternatively, first valve 22 is not employed. In this arrangement, if there is no capacity available in tank 14 pumping to the screen does not occur. Typically, however, tank 14 is sized as an equalization tank, in such a way that there is always capacity.

The first valve is closed when the maximum level is reached. A first receptacle in the form of an anaerobic tank 16 is fed screened wastewater from the feed tank 14 via a second valve 24 by a first pump 26 for anaerobic wastewater processing. The anaerobic tank 16 has a mixer 28 for mixing the screened wastewater therein. The anaerobically processed waste is fed via a third valve 30 by a second pump 32 into the SBR tank 18 for processing prior to being filtered by the filtration unit 20. The SBR tank 18 maintains a predetermined minimum volume of mixed liquor during the entire treatment process. The predetermined minimum volume of mixed liquor is typically 10 to 50 times the volume of screened wastewater to be treated per cycle. During the biological treatment in the SBR tank 18, described in detail below, a bioreactor mixer 33 and a bioreactor aerator 34 are used as required.

A cross-flow submerged membrane filtration arrangement is provided by the filtration unit's 20 inlet and return valves 36 and 37, and inlet and return pumps 38 and 40. An aerator 41 is provided for aeration via an optional valve 42 of the wastewater fed into the filtration unit 20. The aerator 41 provides air to scour the membrane surface to encourage lifting of residue from the filter surface and bring new mixed liquor in contact with the membranes by virtue of the upward air lift pumping effect of large rising air bubbles. Filtrate, or permeate, is drawn from the filtration unit 20 via filtrate valve 43 by an end suction centrifugal pump or a lobe pump 44 and into a filtrate storage tank 46, from where it can be pumped via a filtrate tank valve 47 and pump 48 for use in irrigation, plant washing or mixing with high dry matter waste material prior to subsequent digestion or treatment as needed, or for disposal. Alternatively, the filtrate is drawn from the filtration unit 20 via filtrate valve 43 and into a filtrate storage tank 46 by gravity, without the need for pump 44. Depending on the initial waste stream, or the type of filter used, or local government regulations, the filtrate may require disinfection prior to use. A portion of the solids trapped by the filtration unit 20 (ie. sludge) are fed back to the anaerobic tank 16 by a mixed liquor return valve 49 and pump 50 as mixed liquor feedstock for the anaerobic portion of the process. Unwanted sludge is removed from the filtration unit 20 by a waste valve 52 and pump 54 for disposal or dewatering using known processes prior to disposal, or where appropriate, returned as feed to a biogas facility. It may also be treated or used to replenish the mixed liquor fraction present in the SBR tank 18.

The filtration unit employs hollow fibre microfiltration membranes, typically having a filter pore size in the range of 0.1 to 0.4 μm, although ultrafiltration hollow fibre membranes may also be used. Also, flat sheet microfiltration membrane filters may be used. Total suspended solids (TSS) and turbidity of filtrate from a microfiltration process typically meets recognised international standards for water use. Also, microfiltration removes bacteria from feedstreams and removes viruses associated with filtered particles.

Submerged filtration involves placing filtration membranes in a non-pressurised tank, and drawing filtrate from the filters by an end suction or lobe pump or by gravity. Submerged filtration is advantageous compared with pressurised filtration in that it does not require the use of more expensive pressurised vessels, and in that residue on the filter surface tends to be less compacted and therefore easier to remove. This is advantageous in the filtration of biological wastes, which tend to be non-rigid and sticky, and therefore more difficult to remove from the filter surface especially if compacted thereon. Aside from using known backwashing techniques to clean the membranes, the lifting of sludge residue from the membrane surface is enhanced by the scouring from the aerator 41.

The system is controlled by a controller, such as a programmable logic controller (PLC).

The preferred embodiment of the method will now be described with reference to the above described system. The system operates as a modified intermittent sequential batch reactor (SBR), treating predetermined wastewater volumes over sequential eight-hour cycles. Eight-hour cycles are preferred for convenience as well as effectiveness, although the process may be altered accordingly to conduct shorter or longer cycles.

Prior to the start of each cycle, a preliminary anaerobic contact phase is performed in the anaerobic tank 16. During this phase, a predetermined volume of denitrified mixed liquor is pumped via mixed liquor return valve 49 and pump 50 from the filtration unit 20 to the anaerobic tank 16. A predetermined volume of screened wastewater is then pumped from the feed tank 14 via second valve 24 and first pump 26 to the anaerobic tank 16. The screened wastewater and mixed liquor are then mixed by mixer 28 in anaerobic conditions in the anaerobic tank 16 for about 90 minutes. The mixing is preferably continuous during the entire preliminary anaerobic contact phase. During the preliminary anaerobic contact phase, poly-phosphate bacteria from the mixed liquor release phosphates they have stored to take up volatile fatty acids (VFAs) from the screened wastewater.

In the first SBR phase of each cycle, a predetermined volume portion, preferably a third, of the mixture from the anaerobic tank 16 is pumped through valve 30 by pump 32 to the SBR tank 18 to be combined with the mixed liquor present in the SBR tank 18. The mixture is then aerobically treated, being mixed and aerated by the bioreactor mixer 33 and aerator 34. In this phase, BOD is removed or substantially reduced by heterotrophic organism consumption of carbon, amongst other wastewater components, and nitrification of ammonia present from the screened wastewater after contact with solids in the anaerobic tank is performed by autotrophic organisms. Furthermore, the poly-phosphate bacteria, now in an aerated environment, release VFAs and begin absorbing phosphates from the mixture. The first SBR phase lasts about 120 minutes.

During the second SBR phase of each cycle the aerator 34 is deactivated and a second portion, preferably a third, of the contents of the anaerobic tank is introduced into the SBR tank 18 from the anaerobic tank 16. The mixture in the SBR tank is then mixed by mixer 33 for anoxic treatment. During the second phase, denitrification is performed by the heterotrophic organisms and N₂₍₉₎ released. In prior art systems, an external source of carbon is required for anoxic treatment to feed the heterotrophic organisms to encourage denitrification. There is not enough carbon present in the introduced wastewater of prior art systems, as it is consumed during BOD reduction in aerobic conditions. In the present invention, however, the wastewater to be treated is fed into the SBR tank in portions, rather than as a single volume. Therefore, there is carbon present in the second fed portion to feed the heterotrophic organisms for denitrification. Additional external carbon may also be introduced, if required, preferably in the form of methanol or acetic acid, but other known carbon sources may be used as appropriate. The second SBR phase lasts about 30 minutes.

During the third SBR phase of each cycle, the bioreactor aerator 34 is turned on for aerobic treatment, nitrification of the ammonia present in the second portion is performed, and the phosphate absorption process of the phosphates present completed (or at least significantly completed). The third SBR phase lasts about 90 minutes.

During the fourth SBR phase of each cycle, the bioreactor aerator 34 is turned off for anoxic treatment, and the remaining portion of the anaerobically treated mix is introduced into the SBR tank 18 from the anaerobic tank 16. Carbon present in the remaining portion feeds the heterotrophic organisms for denitrification. An additional external carbon source is supplied, if required. The fourth SBR phase lasts about 30 minutes.

During the fifth SBR phase of each cycle, the bioreactor aerator 34 is turned on for aerobic treatment and nitrification of the ammonia present in the remaining portion is performed. Phosphate absorption of phosphates present in the remaining portion is also performed. The fifth SBR phase lasts about 90 minutes.

During the sixth SBR phase, the aerator is turned off for anoxic treatment. An external carbon source is provided for final denitrification of the remaining nitrates. The sixth SBR phase lasts about 30 minutes. The bioreactor mixer 33 may be operated continually through the six phases.

After the sixth SBR phase, the inlet valve 36, inlet pump 38, return valve 37, return pump 40, filtrate valve 43 and end suction pump 44 are actuated to start the filtration phase. As mentioned above, the filtration phase operates under cross-flow conditions, the process of which would be understood by the skilled addressee. The cross-flow arrangement of the present invention provides about four unit volumes of mixed liquor re-circulation for one unit volume of filtrate. However, depending on the quality of the wastewater being treated, the unit volumes of recirculation per one unit volume of filtrate may lie in the range of 1.5 to 8 volumes of recirculation. During filtration, the mixture being filtered is aerated and the filter membranes scoured by air introduced from filter aerator 41 via valve 42. The filtration phase lasts for about 90 minutes. The filtration phase traps suspended solids, including flocculated bacteria, from the SBR treated wastewater. The bacteria trapped by the filters include the poly-phosphate bacteria, which absorbed phosphates during the relevant SBR phases. Therefore, the amount of phosphate in the filtrate is significantly less than the amount of phosphate present in the screened wastewater.

Filtrate from the filtration phase is drawn by the end suction or lobe pump 44 into the filtrate tank 46 for storage for later use, as described above. The volume of filtrate produced per cycle is equivalent or at least approximately the same as the volume of screened wastewater treated per cycle.

The predetermined volume of mixed liquor pumped to the anaerobic tank 16 from the filtration unit 20 for the preliminary anaerobic solids contact phase is transferred during the sixth SBR phase, such that the screened wastewater is then introduced into the anaerobic tank 16 at or near the end of the sixth SBR phase. The preliminary anaerobic contact phase for the next cycle then proceeds during the filtration phase of the current cycle.

If phosphate removal in addition to the biological phosphate uptake in SBR phases 1, 3 and 5 described above is required, a chemical coagulant, such as alum, polyaluminum chloride or ferric chloride, may be added at the beginning or just prior to any one of SBR phases 1, 3 and 5 to floc additional phosphates present. The floc with phosphates is then removed during the filtration phase.

As will be understood, the system can be sized to accommodate the treatment of relatively small or large volumes of wastewater. For example, it may be sized to accommodate volumes of 2 m³ to 100 m³ per day. These volumes are provided for illustrative purposes, rather than as range limitations.

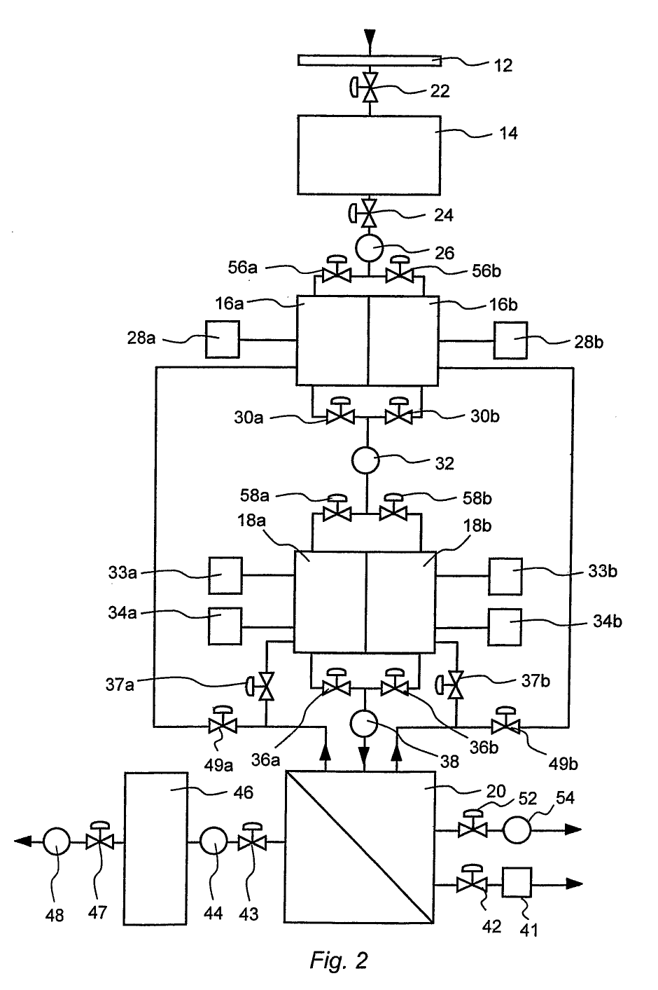

FIG. 2 illustrates another embodiment of the present invention, where like reference numerals denote like parts. This embodiment employs the use of two anaerobic tanks 16a,b and two SBR tanks 18a,b, and associated pumps valves and mixers. Additional anaerobic tank inlet diverter valves 56a,b and SBR tank inlet diverter valves 58a,b are required in this embodiment to ensure separation of flow of waste streams between the two anaerobic tanks 16a,b and two SBR tanks 18a,b. In this embodiment, a primary 8-hour cycle stream is performed via anaerobic tank 16a and SBR tank 18a, and a secondary 8 hour cycle stream is performed via anaerobic tank 16b and SBR tank 18b. The primary and secondary cycle streams run practically identically to each other and follow the same preliminary anaerobic contact, SBR and filtration phases as described above with respect to the first embodiment, however they run 4 hours out of phase with each another. In this way only one filtration unit 20 is required to perform the filtration phase of the biologically treated wastewater at the end of the SBR phases from each of the primary and secondary cycle streams.

Under the above time periods, the anaerobic tank 16, or 16a,b stores at least some liquid for about 5.5 to 6.0 hours, including introducing mixed liquor to the tank 16, or 16a,b prior to the preliminary anaerobic contact phase, the preliminary anaerobic contact phase, and the first to part of the fourth SBR phases. That is, the anaerobic tank 16, or 16a,b stores at least some liquid for more than half of each cycle. For this reason, two anaerobic tanks are required in the above-described second embodiment. As will be understood, the above time periods can be altered depending on the type of waste stream, the volume of each portion of anaerobically treated wastewater introduced into the SBR tank 18, or 18a,b, and the quality requirements of the output filtrate. In another embodiment, therefore, one anaerobic tank and two SBR tanks, and associated pumps valves and mixers, are used. In this embodiment, a primary 8 hour cycle stream is performed via the one anaerobic tank and a first one of the SBR tanks, and a secondary 8 hour cycle stream is performed via the same one anaerobic tank and the second SBR tank. The primary and secondary cycle streams run 4 hours out of phase with each another. However, the time periods of the preliminary anaerobic phase and the first to fourth SBR phases are altered such that their total time is up to 4 hours. In this way, the one anaerobic tank can service both SBR tanks.

Each cycle of the above embodiments is 8 hours. As will be understood, in alternative embodiments, each cycle may be greater or less than 8 hours. Furthermore, where the cycle is less than or greater than 8 hours, the ratio of times per each cycle phase may be the same or different when compared with the 8 hour cycle embodiments described above.

It will be understood that the arrangement of valves and pumps illustrated in the Figures is illustrative only and any configuration achieving the required flow process may be employed. For example, the tank arrangement may be such that pumps are not required on some pipelines, but rather gravity feeding is employed. For example, in the system illustrated in FIG. 2, mixed liquor is able to be gravity fed from the filtration unit 20 to anaerobic tank 16a through valve 49a and to anaerobic tank 16b through valve 49b.

Furthermore, while six SBR phases have been described, fewer or more SBR phases may be used. Also, while the treatment of three preferably equal sized wastewater portions during the SBR phases has been described, the method may be configured for the treatment of three wastewater portions of different volume ratios. For example, the first, second and third portions may comprise 50%, 30% and 20%, respectively, or 40%, 40% and 20%, respectively, of the total preliminary anaerobically treated wastewater volume per cycle. Also, instead of three volume portions of anaerobically treated wastewater introduced in distinct, separated time periods during the SBR phases, two or more than three portions may be introduced.

As is clear from the foregoing description, the present invention has several advantages over prior wastewater treatment systems and methods. For example, by performing a preliminary anaerobic solids contact step in parallel with anoxic, aerobic and filtration steps, the system and method are able to treat a greater volume of wastewater more effectively than conventional SBRs over a comparative time period. Furthermore, by having a separate tank dedicated to anaerobic solids contact, the anaerobic contact phase can be controlled and performed more effectively than if it were performed as a sequential step in the SBR tank, as conventionally practiced. Another advantage of the present invention is that the feedstock treated in the SBR is fed into the SBR in distinct portions throughout the SBR treatment phases rather than as a single batch at the beginning of the SBR treatment phases. This means that, as explained above, carbon is available from the feedstock portions to promote denitrification, when appropriate, and therefore the amount of external carbon source (such as methanol or acetic acid) required to be introduced into the system is significantly reduced. The resultant system, also employing the use of a microfiltration or ultrafiltration unit, has a reduced footprint compared to prior art treatment systems and is able to produce treated wastewater which meets local requirements for discharge and wastewater reuse.

If extremely low phosphate content is required in treated wastewater, the anaerobic solids contact phase, performed in the anaerobic tank 16, is combined with the addition of a chemical coagulant, such as a known aluminium or iron-based coagulants. This forms an aluminium- or ferric phosphate floc with most of the phosphate present, which is removed during the filtration phase. The remaining phosphate is taken up biologically.

In an alternative embodiment of the invention, when wastewater contains low phosphorus, or no phosphorus removal is required, wastewater is treated in the same sequential manner as described above with respect to the six SBR phases, however the external anaerobic tank 16 described above is not used; screened wastewater is instead fed directly to the SBR tank 18 in the predetermined volume portions, and no biological phosphorous removal occurs in the SBR tank.

In this variation, an aluminium or iron-based chemical coagulant, may be added to the SBR tank 18 at the same time, or immediately prior to the addition of each screened wastewater portion, if phosphorus removal is desired. The floc produced is eventually removed from the wastewater stream during the filtration phase.

While the invention has been described in reference to its preferred embodiments, it is to be understood that the words which have been used are words of description rather than limitation and that changes may be made to the invention without departing from its scope as defined by the appended claims.

Each feature disclosed in this specification (which term includes the claims) and/or shown in the drawings may be incorporated in the invention independently of other disclosed and/or illustrated features.

Statements in this specification of the “objects of the invention” relate to preferred embodiments of the invention, but not necessarily to all embodiments of the invention falling within the claims.

The description of the invention with reference to the drawings is by way of example only.

The text of the abstract filed herewith is repeated here as part of the specification.

A method for treating wastewater is disclosed. In step a), a predetermined volume of the wastewater is mixed in a first receptacle with a predetermined volume of sludge-containing returned denitrified mixed liquor under anaerobic conditions for a predetermined time period to produce an anaerobically mix rich in released phosphates. In step b), at least a portion of the anaerobically treated mix is then treated in a second receptacle under aerobic and anoxic conditions to produce a part-treated mix. In step c) at least a portion of solids from the part-treated mix to produce a low reduced-solids effluent. Steps b) and c) are sequential and cyclical and the treatment in step a) occurs during one or both of steps b) and c). In an alternative method, a predetermined volume of wastewater is treated under aerobic and anoxic conditions to produce a part-treated mix. The predetermined volume of wastewater is treated in two or more distinct portions, and a predetermined time period elapses between the introduction of each of the portions. In this method, carbon present in one or more of a second or subsequent said distinct portion(s) is available for use in treatment under said anoxic conditions during step a).

1-32. (canceled)

33. A method of sequentially treating wastewater, the method comprising the steps of:
a) in a first receptacle, mixing a predetermined volume of the wastewater with a predetermined volume of sludge (as herein defined) under anaerobic conditions for a predetermined time period to produce an anaerobically treated mix;
b) in a second receptacle, treating at least a portion of the anaerobically treated mix, under aerobic and anoxic conditions to produce a part-treated mix; and
c) removing at least a portion of solids from the part-treated mix to produce a reduced-solids effluent,
wherein steps b) and c) are sequential and cyclical and the treatment in step a) occurs during one or both of steps b) and c).

34. The method of claim 33 , wherein the treatment in step a) for one cycle occurs during one or both of steps b) and c) of a cycle preceding said one cycle.

35. The method of claim 33, wherein the at least a portion of solids removed in step c) are introduced into the first receptacle to form at least a part of the predetermined volume of sludge in step a).

36. The method of claim 33 , wherein the at least a portion of solids removed in step c) of one cycle are introduced into the first receptacle during step b) of a subsequent cycle to form at least a portion of the predetermined volume of sludge of step a).

37. The method of claim 33 , wherein in step a), the predetermined volume of the wastewater for subsequent treatment in step b) of one cycle is introduced into the first receptacle during step b) of a cycle preceding said one cycle.

38. The method of claim 33, wherein in step a), the predetermined volume of the wastewater is mixed with the predetermined volume of sludge under anaerobic conditions to produce the anaerobically treated mix for one cycle during the step c) of a cycle preceding said one cycle.

39. The method of claim 33 , wherein the second receptacle contains a predetermined volume of mixed liquor prior to the start of step a).

40. The method of claim 33 , wherein the volume of effluent produced in step c) is approximately equal to the volume of wastewater introduced into the first receptacle in step a).

41. The method of claim 33 comprising providing the sludge to the first receptacle in step (a) in liquid suspension as a mixed liquor after a denitrification treatment.

42. The method of claim 33 wherein the anaerobically treated mix produced in step (a) is rich in released phosphorus.

43. The method of claim 33 wherein in step (b) the anaerobically treated mix is further treated to reduce dissolved BOD, nitrogen and phosphorus.

44. A method for treating wastewater comprising the steps of:
a) treating a predetermined volume of wastewater under aerobic and anoxic conditions to produce a part-treated mix, wherein the predetermined volume of wastewater is treated in two or more distinct portions, and a predetermined time period elapses between the introduction of each of the portions; and
b) removing at least a portion of solids from the part-treated mix to produce a reduced-solids effluent,
wherein carbon present in one or more of a second or subsequent said distinct portion(s) is available for use in treatment under said anoxic conditions during step a).

45. The method of claim 44, wherein step a) comprises the steps of:
a1) aerobically treating a first portion of the predetermined volume of wastewater;
a2) introducing a second portion of the predetermined volume of wastewater to the first portion and anoxically treating the first and second portions; and
a3) aerobically treating the first and second portions.

46. The method of claim 45, wherein step a) further comprises the steps of
a4) introducing a third portion of the predetermined volume of wastewater to the first and second portions and anoxically treating the first, second and third portions;
a5) aerobically treating the first, second and third portions; and
a6) anoxically treating the first, second and third portions.

47. The method of claim 44, wherein steps a) and b) are cyclical.

48. The method of claim 44 wherein in step a), the portions of wastewater are introduced to a predetermined volume of mixed liquor for the treatment.

49. The method of claim 44, wherein the predetermined volume of wastewater is pretreated under anaerobic conditions prior to step a).

50. The method of claim 49, wherein the anaerobic pretreatment occurs during one or both of steps a) and b).

51. The method of claim 44, wherein the volume of effluent produced in step b) is approximately equal to the predetermined volume of wastewater treated in step a).

52. The method of claim 44, wherein step a) includes treatment under anaerobic conditions.

53. The method of claim 33, wherein the step of removing the at least a portion of solids is performed by filtration.

54. The method of claim 33, wherein the step of removing the at least a portion of solids is performed by settling and clarification.

55. The method of claim 44, wherein the part-treated mix produced in step (a) has reduced dissolved BOD, nitrogen and phosphorus.

56. A system for the sequential batch-treatment of wastewater, the system comprising:
a first receptacle for anaerobic treatment of wastewater;
a second receptacle in communication with the first receptacle for distinct aerobic and anoxic treatment of anaerobically treated wastewater from the first receptacle;
apparatus for removal of solids from a portion of the aerobically and anoxically treated wastewater; and
a controller programmed to control the system:
a) to mix, in the first receptacle, a predetermined volume of the wastewater with a predetermined volume of sludge (as herein defined) under anaerobic conditions for a predetermined time period to produce an anaerobically treated mix;
b) to treat in the second receptacle, at least a portion of the anaerobically treated mix, under aerobic and anoxic conditions to produce a part-treated mix; and
c) to remove at least a portion of solids from the part-treated mix to produce a reduce-solids effluent,
d) to perform steps b) and c) sequentially and cyclically and to perform the treatment in step a) during one or both of steps b) and c).

57. The system of claim 56 comprising apparatus for charging the first receptacle with influent wastewater and sludge-bearing mixed liquor from an earlier treatment.
